(19) United States
(12) Patent Application Publication
(10) Pub. No.: US 2020/0329128 A1
(43) Pub. Date: Oct. 15, 2020

(54) DYNAMIC DETECTABILITY OF RTCP-FEEDBACK SUPPORT

(71) Applicant: QUALCOMM Incorporated, San Diego, CA (US)

(72) Inventors: Shubhra SINGH, Bengaluru (IN); Sandeep PADUBIDRI RAMAMURTHY, Bengaluru (IN); Shankar Ganesh LAKSHMANASWAMY, Bengaluru (IN)

(21) Appl. No.: 16/379,342

(22) Filed: Apr. 9, 2019

(51) Int. Cl. H04L 29/06; H04N 7/14; H04N 21/643

(52) U.S. Cl. CPC H04L 69/24; H04L 65/80; H04N 21/643; H04N 7/147; H04L 65/608

(57) ABSTRACT

Various protocols have been defined that computing devices can use to establish a real-time communication session. These protocols can describe techniques by which the computing devices can negotiate the parameters to use in the communication session, so that each device transmits media that the other device or devices are able to accept. Feedback mechanisms aid in correcting issues with media streams. Techniques can be used to determine the feedback mechanisms supported by a computing device on a session, when the computing device indicates that the computing device supports feedback, but does not specify the types of feedback that the computing device supports. These techniques can include sending a message that requires a response. When the response is received, the sending device can determine a feedback type supported by the receiving device.

### BACKGROUND

Internet Protocol (IP) Multimedia Subsystem (IMS) is an architectural framework that enables multimedia and voice communications over IP-based networks. IMS includes a body of communication protocols and standards that enable computing devices, while connected to disparate types of networks, to gain access to multimedia content and to intercommunicate using voice and/or video. IMS, for example, provides for intercommunication between Global System for Mobile communication (GSM), Wideband Code Division Multiple Access (WCDMA), Code Division Multiple Access 2000 (CDMA2000), Wireless Local Area Network (WLAN), Worldwide Interoperability for Microwave Access (WiMAX), Long-Term Evolution (LTE), 3G, 4G, 5G, and wired broadband networks, other types of networks, and also future network types.

Among other protocols, IMS uses Session Initiated Protocol (SIP) to initiate, maintain, and terminate real-time sessions between devices on an IMS-enabled network. For example, SIP can be used for signaling and controlling multimedia communication sessions, which can include voice and video calls (e.g., Internet telephony), IP telephone systems, instant messaging over IP networks, and mobile phone calling over LTE networks, among other examples. SIP can work in conjunction with other protocols that specify and carry that carry the session media. for example, media type and parameter negotiation as well as media set-up can be performed with the Session Description Protocol (SDP), which is carried as payload in SIP messages. As another example, for transmission of media streams, which can include voice and video, the SDP payload can use Real-time Transport Protocol (RTP) or Secure Real-time Transport Protocol (SRTP). SIP is independent of the underlying transport protocol of the network, and can be used with User Datagram Protocol (UDP), Transmission Control Protocol (TCP), or Stream Control Transmission Protocol (SCTP), among other examples.

### BRIEF SUMMARY

Provided are systems, methods, and computer-readable media describing techniques for session negotiation between computing devices communicating over a network. Various protocols have been defined that computing devices can use to KTS Ref. No. 1112678 1 establish a real-time communication session. These protocols can describe techniques by which the computing devices can negotiate the parameters to use in the communication session, so that each device transmits media that the other device is able to (e.g., configured to) accept and process. Feedback mechanisms aid in correcting issues with media streams. In various examples, techniques can be used to determine the feedback mechanisms supported by a computing device engaged in a session: for example, when the computing device indicates that the computing device supports feedback but does not specify the types of feedback that the computing device supports.

According to at least one example, a method for multimedia communications is provided that includes transmitting, by a sending device, a first packet, the first packet including suggested parameters for a communication session with a receiving device. The method further includes receiving, at the sending device, a first response packet, the first response packet indicating parameters selected, from the suggested parameters, by the receiving device, wherein the parameters selected include use of feedback messages for adjusting parameters of the communication session, and wherein the first response packet does not specify any type of the feedback messages. The method further includes transmitting, by the sending device, a second packet to the receiving device, the second packet being of a type that requires a response from the receiving device. The method further includes receiving, at the sending device, a second response packet in response to the second packet. The method further includes configuring, by the sending device, the parameters of the communication session to use feedback messages of a type associated with the type of the second packet.

In another example, a computing device is provided that includes a processor and a non-transitory computer-readable medium having stored thereon instructions that, when executed by the processor, cause the processor to transmit a first packet, the first packet including suggested parameters for a communication session with a receiving device. The instructions can further cause the processor to perform operations including receiving a first response packet, the first response packet indicating parameters selected, from the suggested parameters, by the receiving device, wherein the parameters selected include use of feedback messages for adjusting parameters of the communication session, and wherein the first response packet does not specify any type of the feedback messages. The instructions can further cause the processor to perform operations including transmitting a second packet to the receiving device, the second packet being of a type that requires a response from the receiving device. The instructions can further cause the processor to perform operations including receiving a second response packet in response to the second packet. The instructions can further cause the processor to perform operations including configuring the parameters of the communication session to use feedback messages of a type associated with the type of the second packet.

In some aspects, the computing device further comprises a camera and a microphone. In some aspects, the computing device further comprises a mobile device.

In another example, a computer-readable medium is provided having stored thereon instructions that when executed by a processor, cause the processor to perform operations including transmitting a first packet, the first packet including suggested parameters for a communication session with a receiving device. The instructions can further cause the processor to perform operations including receiving a first response packet, the first response packet indicating parameters selected, from the suggested parameters, by the receiving device, wherein the parameters selected include use of feedback messages for adjusting parameters of the communication session, and wherein the first response packet does not specify any type of the feedback messages. The instructions can further cause the processor to perform operations including transmitting a second packet to the receiving device, the second packet being of a type that requires a response from the receiving device. The instructions can further cause the processor to perform operations including receiving a second response packet in response to the second packet. The instructions can further cause the processor to perform operations including configuring the parameters of the communication session to use feedback messages of a type associated with the type of the second packet.

In another example, an apparatus is provided that includes means for transmitting a first packet, the first packet including suggested parameters for a communication session with a receiving device. The apparatus can further include means for receiving a first response packet, the first response packet indicating parameters selected, from the suggested parameters, by the receiving device, wherein the parameters selected include use of feedback messages for adjusting parameters of the communication session, and wherein the first response packet does not specify any type of the feedback messages. The apparatus can further include means for transmitting a second packet to the receiving device, the second packet being of a type that requires a response from the receiving device. The apparatus can further include means for receiving a second response packet in response to the second packet. The apparatus can further include means for configuring the parameters of the communication session to use feedback messages of a type associated with the type of the second packet.

In some aspects, the suggested session parameters include a profile for adjusting the parameters of the communication session. In some aspects, the second packet includes a suggested bit rate. In some aspects, the second response packet indicates that the receiving device supports feedback messages of the type of the second packet.

In some aspects, the methods, apparatuses, and computer-readable medium described above further comprise determining, by the sending device, that a second receiving device has joined the communication session. These aspects further comprise transmitting, by the sending device, a third packet to the second receiving device, the third packet being of a same type as the second packet. These aspects further comprise determining, by the sending device, that no response to the third packet was received. These aspects further comprise configuring, by the sending device, the parameters of the communication session to not use feedback messages.

In some aspects, the methods, apparatuses, and computer-readable medium described above further comprise receiving, at the sending device, a periodic report message from the receiving device, the periodic report message including information about the communication session. These aspects further comprise determining, from the periodic report message, a particular type of feedback message supported by the receiving device.

In some aspects, the communication session is established over a network that includes session-based services for data exchanges, and the session-based services use a signaling protocol for real-time communication sessions, wherein the signaling protocol operates on top of a networking protocol. In some aspects, the communication session includes a video call.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative examples are described in detail below with reference to the following figures:

FIG. 1 includes a diagram illustrating a system in which computing devices can connect to one another for real-time communication sessions;

FIG. 2 includes a block diagram of a computing device that can be used to participate in a communication session;

FIG. 3 includes a flow diagram illustrating an example of an exchange of messages between a sending device and receiving device;

FIG. 4 includes a flowchart illustrating an example of a process for multimedia communications; and

FIG. 5 includes a block diagram illustrating a system according to the IP Multimedia Subsystem (IMS) architectural framework.

### DETAILED DESCRIPTION

Computing devices, such as laptop computers, desktop computers, smart phones, tablet computers, and others, can be used for real-time communications between users of the devices. Real-time, in this context, means that the operators (e.g., people) of the computing devices can have an immediate exchange of information, with little to no perceptible delay between the time at which one operator provides information (e.g., in the form of voice and/or video) and the time at which the other operator (e.g., another person) receives the information. For example, one user can use a computing device to communicate with (e.g., “call”) another user, and the two users can then have a live communication session (e.g., a voice and/or video conversation). From the user's perspective, calling, in this context, can be similar to traditional telephone calls, where one dials a phone number on a handset. Alternatively or additionally, when the computing device includes a camera and a screen, the call can include video content, in addition to or as an alternative to audio content.

In various examples, the Internet Protocol Multimedia Subsystem (IMS) infrastructure, and the communication protocols specified by IMS, enables voice and/or video calling between different types of computing devices and over different types of networks. When a user initiates a call on an IMS-enabled network, the user can specify a phone number, an email address, a user identifier, or another type of identifier for the intended recipient of the call. The user's computing device can use a nearby network (which can be a wired, wireless, or cellular network, among other examples) to send a call invite that includes the identifier to a service provider, such as a cellular telecommunications provider, a voice-over-IP (VOIP) provider, or an Internet Service Provider (ISP), among others. The service provider may be able to locate the identified call recipient (i.e., the intended recipient of the call) and/or may connect to another service provider to find the call recipient. Once the call recipient has been found, the service provider sends the call invite to one or more devices associated with the recipient. These devices can then generate a notification that alerts the recipient. In some cases, when the recipient does not respond to (e.g., does not “answer”) the notification(s) of the call invite within a certain amount of time, the session is ended, and the caller is notified that the call was not connected. When the recipient accepts the call invite, a live communication session is started between the caller's computing device and the recipient's user device.

Starting a session between a caller's device and a recipient's device can include an exchange of data between the devices to establish parameters for the session. These parameters can include, for example, an audio encoding type, a video encoding type, a sampling type, the number of bits per sample, a sampling rate, a frame rate, and/or other information. Determining the parameters of the session not only enables two devices to communicate with one another, but can also enable the devices to accommodate differences in, for example, hardware capabilities, connection speeds, and bandwidth availability, among other examples.

To determine session parameters, a calling device can use, for example, the Audio-Visual Profile (AVP), which is a profile of the Real-Time Transport Protocol (RTP). RTP/AVP is defined in Request for Comments (RFC) 3551. Using packets formatted according to AVP, the device initiating the call (i.e., transmitting the call invite) can announce, to the device receiving the call invite (e.g., the intended recipient) information such as, but not limited to: the name of an encoding that the initiating device will use; whether the initiating device will send audio, video, or both; and/or a transmission frequency, among other information.

With AVP, a device receiving media data from the communication session can use mechanisms of the underlying Real-Time Transport Control Protocol (RTCP) to report packet reception statistics. The device sending the media data can use these reports to adapt its transmission behavior once the session has started. This mechanism was considered a shortcoming of AVP, however, because the minimum interval between RTCP reports from the receiving device is five seconds. Because RTCP does not provide another way for a receiver detecting an issue to communicate the issue to the sending device, the sending device can make a corresponding correction to the media stream only as quickly as the RTCP report interval allows.

Some computing devices thus use the Audio-Visual Profile Feedback (AVPF) profile. AVPF is defined in RFC 4585 and RFC 5104. AVPF provides for feedback messages, which a receiving device can send to convey information about events, observed at the receiver, to the sending device. The feedback messages can be sent as early as the start of the session, so that the sending device can determine parameters that are suitable for the capabilities and network conditions of the receiving device. The receiving device can also send feedback messages at other times, such as when the receiver detects an error in the media stream.

At the start of a session, a sending device can announce to receiving device(s) on the session that the sender (i.e., the sending device) supports AVPF, for example, by indicating such in a session description. When the receiver also supports AVPF, the receiver can send a response message to the sender to indicate support for AVPF. RFC 4585, however, does not require the receiver to support all types of feedback messages, and also does not require the receiver to specify, in a response to the sender, which types of feedback messages the receiver supports. Without this information (e.g., the types of feedback message(s) the receiver supports), the sender may be unable to determine which mechanisms to use to establish the session parameters. In some cases, in response to not receiving or not being made aware of the information above, the sender may consequently revert to non-use of feedback messages in the establishment of session parameters, such as using AVP to establish session parameters. Not using feedback messages, however, can lead to issues (for example: audio distortions, visual artifacts, lag, etc.) until the sender receives a RTCP report from the receiver. Typically, a receiver transmits RTCP reports not less than five seconds apart.

In various implementations, techniques can be used by a computing device that participates in a communication session with another computing device to establish a type of mechanism that the other computing device supports for determining parameters of the communication session. In various examples, when one device on a real-time communication session announces that the device is able to send feedback messages, but does not specify (or indicate) which types of feedback messages, a second device on the session can probe the first device to discover (i.e., determine) at least some of the types of feedback messages that the first device supports. In various examples, the second device can perform the probing early in the session (e.g., as early as during call setup and/or prior to transmission of media content), so that both devices can establish the feedback mechanism before the users on the call experience poor call quality.

For purposes of clarity, the device that performs the probing will be referred to herein as the sending device or sender, and the device that is being probed will be referred to as the receiving device or receiver, though in some communication sessions, either device can be a sender or a receiver at different times. For example, during a video call, both devices can be sending video and audio streams, and both devices can be recipients of the other's video and audio streams. For purposes of the discussion that follows, it will be assumed that the device that initiates a communication session is the sender in the session and will perform the probing, though, in various examples, the device that is the target of the session can also perform the probing.

In various examples, to establish the feedback message types that a receiver supports, the sender can send a message (e.g., in a network packet) that requires a response from the receiver in the form of a type of feedback message. For example, the sender can send to the receiver (e.g., before or during the exchange of media content) a suggested bit rate for the communication session. In this and other examples, the receiver's response can indicate to the sender that the receiver at least supports this feedback message type, and that the sender can use messages of this type to negotiate the session parameters with the receiver. When the receiver does not respond, or the receiver's response message is lost, the sender can revert to a sender-side rate adaptation mode. Because the receiver apparently supports feedback messages, however, the sender need not stay in sender-rate adaptation mode, and can retry the probe message, or can use other techniques for deriving the receiver's supported feedback message types.

Using the techniques discussed herein, a sending device can initiate a communication session with a receiving device, and can establish a mechanism by which the receiving device can quickly report issues with the session to the sender (e.g., without waiting for the interval to the next RTCP report). The sender can then attempt to correct the issues without further delay. Voice and video calling can thus be improved.

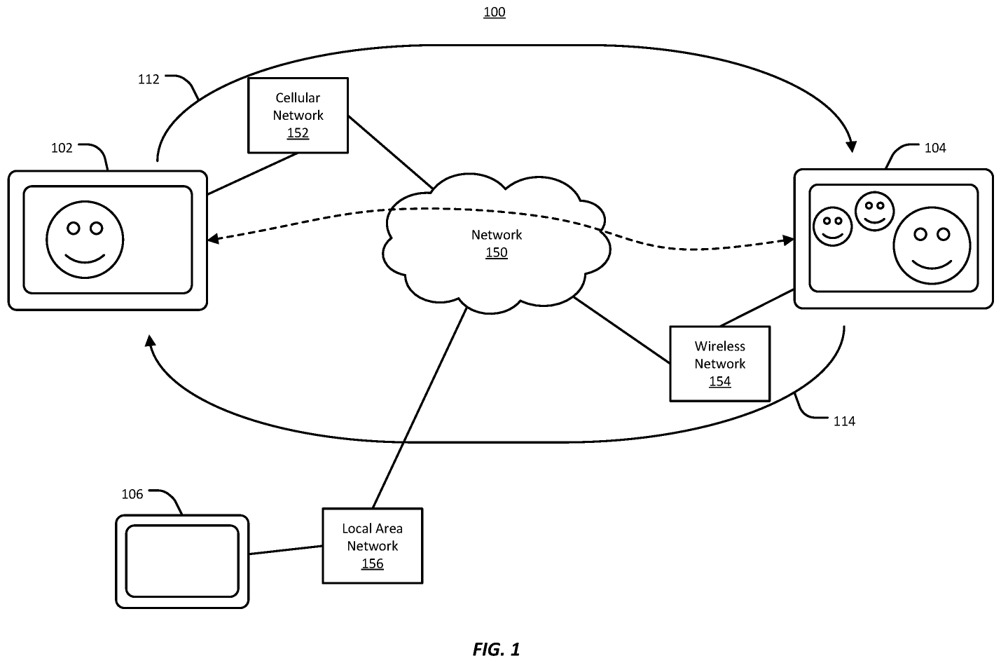

FIG. 1 includes a diagram illustrating a system 100 in which computing devices can connect to one another for real-time communication sessions. The computing devices in this example system 100 can include devices such as laptop computers, desktop computers, server or rack-mounted computers, smart phones, tablet computers, other handheld computing devices, and other devices include a processor that is able to execute program code and are capable of connecting to a network. In the example of FIG. 1, the computing devices include at least a screen, a microphone, a speaker. The computing devices can also include components such as keyboards and/or touchscreens for inputting text.

The system 100 of FIG. 1 includes a first computing device 102, which, in this example, is capable of connecting to a cellular network 152. In various examples, the cellular network 152 is a land-based network that includes cell towers, which can receive radio signals within a certain radius (referred to as a cell). Devices, such as the first computing device 102, can connect to the cell tower wirelessly using a radio antenna, when the devices are within the cell of the cell tower. The cellular network 152 can enable the first computing device 102 to connect to the Public Switched Telephone Network (PSTN) and to the public Internet. Using the cellular network 152, the first computing device 102 can, for example, place telephone calls or send text messages on the PSTN. With access to the Internet, the first computing device 102 can also, for example, send email, send instant messages, post to social media feeds, and perform other operations for exchanging information with other devices in the system 100. Different cellular networks can use different radio frequencies. Examples of cellular networks include networks based on GSM, WCDMA, CDMA2000, LTE, 3G, 4G, 5G, and other mobile communication standards.

The example system 100 further includes a second computing device 104, which, in this example, is connected to a wireless network 154. The wireless network 154 can include one base station or multiple base stations that can transmit and receive network data on a particular frequency, which is generally shorter range that the frequencies used by cellular networks. Devices such as the second computing device 104 can include an antenna for connecting to the base stations. The base stations can be connected to a local area network, over which the second computing device 104 can access other packet-switched networks, including the Internet. Specifications for radio frequencies, handshake signaling, security, and other aspects of wireless networks can be found in the Institute for Electrical and Electronics Engineers (IEEE) 802.11 (for Wi-Fi) and 802.16 (for WiMAX) standards, among other documents.

The example system 100 further includes a third computing device 106, which, in this example, is connected to a local area network 156. The local area network 156 can be a packet-switched network, and can include a router or a switch that the third computing device 106 can connect to using a physical cable. Alternatively, the local area network 156 can be another type of wired network, such as a Token Ring network, a Fiber Distributed Data Interface (FDDI) network, or another type of wired network. In these and other examples, the local area network 156 can include a gateway device, through which the local area network 156 can connect to other networks.

Each of the cellular network 152, the wireless network 154, and local area network 156 enable the first computing device 102, the second computing device 104, and the third computing device 106 to connect to a larger network 150. The network 150 of this example includes the global Internet, and may possibly also include other public or private networks. By having access to this common network 150, computing devices in the system 100 can connect to one another and establish communication sessions for having real-time audio and/or video data exchanges. The network 150, for example, can include an IMS infrastructure, which can enable set-up and management of communication sessions between the computing devices.

As an example, a user of the first computing device 102 can initiate a session with the second computing device 104. The first computing device 102 is the sender or sending device, in this example. The user can, for example, input into an input interface of the first computing device 102 a telephone number, an email address, or another type of identifier for the receiver of the session. A service provider on the network 150 can map the identifier to one or more devices associated with the identifier. Each device on a network can have, for example, a Uniform Resource Identifier (URI), which uniquely identifies the device on the network. The service provider can have a directory that associates information, such as telephone numbers and email addresses, with particular URIs. In some cases, the user associated with the identifier may have more than one device, such as a laptop and a smartphone, that the user has associated with the identifier. In some cases, each of these devices can receive a notification of the incoming session. In some cases, a designated device will receive the notification, and can trigger an audible and/or visual alert to bring the incoming session to the attention of the user.

In the preceding example, initiating and establishing the communication session can be performed, for example, using the Session Description Protocol (SDP). SDP can be used for session announcement, session invitation, and parameter negotiation for multimedia communication sessions. SDP packets can be sent, for example, between the first computing device 102 and the second computing device 104 to negotiate the media type and media format for the session, as well as associated parameters. The parameters may be referred to as a session profile.

SDP packets can be carried as payload in Session Initiation Protocol (SIP) packets. SIP can be used for the signaling operations of a communication session, including to set up and terminate voice or video calls. SIP can be used to establish two-party (unicast) or multiparty (multicast) sessions. SIP can also be used to modify existing sessions, such as changing addresses or ports, inviting more participants, and adding or deleting media streams.

A session can be described in an SDP message using a series of fields, where each field includes a character and a value. The character can be case-sensitive, and the value can be structured text whose format depends on the type of attribute described by the field. An SDP message can include three sections, describing the session, timing, and media for the session. A message can contain multiple timing and media descriptions. The following is an example list of fields and the data that can be provided using these fields. Optional fields are specified with “=*”.

Session description:
v=(protocol version number, currently only 0)
o=(originator and session identifier: username, id, version number, network address)
s=(session name: mandatory with at least one UTF-8-encoded character)
i=* (session title or short information)
u=* (URI of description)
e=* (zero or more email addresses with optional name of contacts)
p=* (zero or more phone numbers with optional name of contacts)
c=* (connection information—not required if included in all media)
b=* (zero or more bandwidth information lines)
z=* (time zone adjustments)
k=* (encryption key)
a=* (zero or more session attribute lines)

Time description:
t=(time the session is active)
r=* (zero or more repeat times)

Media description:
m=(media name and transport address)
i=* (media title or information field)
c=* (connection information—optional if included at session level)
b=* (zero or more bandwidth information lines)
k=* (encryption key)
a=* (zero or more media attribute lines—overriding the Session attribute lines)

The following is an example session description that may be sent by, for example, the first computing device 102 to the second computing device 104 at the start of a session:

v=0

o=jdoe 2890844526 2890842807 IN IP4 10.47.16.5

s=SDP Seminar

i=A Seminar on the session description protocol

u=http://www.example.com/seminars/sdp.pdf

e=j.doe@example.com (Jane Doe)

c=IN IP4 224.2.17.12/127

t=2873397496 2873404696

a=recvonly

m=audio 49170 RTP/AVP 0

m=video 51372 RTP/AVP 99

a=rtpmap:99 h263-1998/90000

The preceding example session description indicates that the session was originated by the user “j doe”, at IPv4 address 10.47.16.5. The session is given the name is “SDP Seminar” and extended session information (e.g., “A Seminar on the session description protocol”) is included, along with a link for additional information and an email address to contact the responsible party, Jane Doe. Network Time Protocol (NTP) timestamps “2873397496” and “2873404696” indicate that the session is to last for two hours. A connection address (which indicates the address clients must connect to or, when a multicast address is provided, as it is here, subscribe to) is specified as IPv4 224.2.17.12 with a time-to-live (TTL) of 127. Recipients of this session description are instructed to only receive media. Two media descriptions are provided, both using RTP Audio Video Profile (AVP). The first is an audio stream on port 49170 using RTP/AVP payload type 0 (defined by RFC 3551 as Pulse Code Modulation μ-law (PCMU)), and the second is a video stream on port 51372 using RTP/AVP payload type 99 (defined as “dynamic”). An attribute is also included that maps RTP/AVP payload type 99 to format h263-1998 with a 90 kHz clock rate. RTCP ports for the audio and video streams of 49171 and 51373, respectively, are implied.

As illustrated by the preceding example, SDP can be used to describe multimedia sessions for the purposes of session announcement, session invitation, and other forms of multimedia session initiation. An SDP session description can contain one or more media stream descriptions with information such as an IP address and port, a type of media stream (e.g., audio or video) to be used in the session, a transport protocol (possibly including profile information, e.g., RTP/AVP or RTP/AVPF), media formats (e.g., codecs), and various other session and media stream parameters that define the session. A computing device that wants to join the session can obtain the session announcement, and can use the media descriptions therein to configure itself for receipt of media packets in the encoded format specified. If the computing device does not support the media stream description, the computing device may be unable to receive the media. It is further noted that example system 100 may include multiple instances of first computing device 102, second computing device 104, and/or third computing device 106, such that a session description as in the example above may be sent by any of these devices to initiate a session with any other of the devices of example system 100.

In a two-way or multi-way calling situation, it is unacceptable for a computing device to be unable to join the session. Instead, the devices in the session should be able to determine a set of session parameters that are acceptable to all of the devices on the session. For this reason, various extension to SDP were defined. For example, RFC 3264 defines an offer/answer model, in which one device (the offerer) streams, codecs, and other SDP parameters that the offerer is willing to use. This offer session description is sent to another device on the session (the answerer), which can choose from among the media streams, codecs, and other session description parameters provided, and generates an answer session description with the chosen parameters, based on that choice. The answer session description is sent back to the offerer thereby completing the session negotiation and enabling the establishment of the negotiated media streams.

As another example, RFC 5939 introduces SDP Capability Negotiation, a framework that uses SDP and the offer/answer model to establish the parameters for a session. SDP Capability Negotiation enables an offerer to announce an actual configuration of the session, as well one or more alternative session descriptions. The answerer can choose the actual configuration or one of the alternative session descriptions, and generate an answer SDP description that includes the selected description. The offerer can then use the answer's response to configure the session, if necessary.

The above-described example session description can be an example of an actual session configuration or an alternative configuration, generated by a computing device operating as the offerer. In this example, the offerer is suggesting RTP/AVP as the profile for the audio and video data streams. AVP is a profile for RTP that enables the sender to specify the parameters for the audio and/or video streams of the session. RTP specifies a general-purpose data format, but does not specify how encoded data should use the features of RTP. For example, RTP does not specify the payload type value to put in an RTP header, a sampling rate and clock rate at which the RTP timestamp increments, and so on. An RTP profile such as AVP can specify these details: for example, by specifying a mapping of specific audio and video codecs and sampling rates for these codecs to RTP payload types and clock rates. The profile can further specify how to encode each data format as an RTP data payload, as well as specify how to describe these mappings using SDP.

As noted previously, however, while the sender can use AVP to announce the media parameters, the receiver is not provided with a mechanism to respond to the announcement. Instead, the sender may rely on periodic RTCP reports from the receiver to determine whether the media parameters are or are not acceptable to the receiver. RTCP is a companion protocol to RTP, and is used to communicate statistics and control information for an RTP session. RTCP packets do not transport any media data, and can be sent “out-of-band” (i.e., over a connection that is separate from the RTP flow). All participants (e.g., both senders and receivers) in a session are expected to send RTCP reports, and the time interval between RTCP reports from different participants may be randomized to avoid unintended synchronization of reporting. RTCP reports are typically separated by a minimum interval of five seconds, however, so that a delay may occur between the time at which the receiver determines that there are issues with a media stream and the time at which the sender is able to make a corresponding change to the media stream. A receiver may thus experience poor audio and/or video quality until the sender is informed, by way of the next RTCP report, that the sender needs to make changes to the stream.

For this reason, the sender can use the RTP/AVPF profile instead of AVP. For example, in the above example session description, the media name and transport address fields can specify “RTP/AVPF” instead of “RTP/AVP.” The RTP/AVPF profile provides for “early RTCP mode” and feedback messages, among other messages, which receivers may be able to send earlier than is allowed by the RTCP reporting mechanism. The sender can then use these messages to make changes to the media stream in a more timely fashion then when receipt of feedback from receivers is dictated by the RTCP reporting interval. The AVPF profile provides additional attributes that a sender can include in a session description to announce the types of feedback messages that the sender supports. The receiver on the session can use this information to select appropriate feedback messages when reporting issues with the media stream.

In a communication session, computing devices that support AVPF may only be able to receive feedback messages from other computing devices that support AVPF. Thus, the devices in the session can use the offer/answer protocol of SDP Capability Negotiation to establish that both the offerer and the answer are capable of using AVPF. For example, a computing device that initiates a session (the offerer, in this example) can include AVPF in the actual configuration for the session, as well as in alternative session descriptions, and can include as attributes the types of feedback mechanisms that the offerer supports. A device joining the session (the answerer, in this example), can include in an answer to the offer that the answerer also supports AVPF. AVPF, however, does not require the answer to provide a listing of the types of feedback that the answerer supports. This means that, in some cases, the offerer is informed by the answerer's response that the AVPF is an acceptable method for determining media parameters, but may not be able to determine the methods by which the offerer can send feedback to the answerer. In this situation, the offerer may resort to not using feedback messages, and possibly configuring the session for AVP to avoid invalid feedback messages to be sent.

As noted previously, using AVPF is preferable to using AVP, because problems in the media stream can be repaired more quickly when feedback messages are available. Thus, in various implementations, a computing device used for real-time communication sessions in a system such as illustrated in FIG. 1 can include techniques for probing another computing device to determine feedback mechanisms supported by the other device. For example, the first computing device 102 can be the initiator of a call with the second computing device 104, and can be the offerer in negotiations to establish the session parameters. In this example, as the offerer, the first computing device 102 can indicate in an offer message that the first computing device 102 is able to use AVPF. When the second computing device 104, acting as the answerer in this example, sends an answer message that the second computing device 104 can use AVPF but fails to specify the types of feedback that the second computing device 104 supports, the first computing device 102 can then initiate a probe of the second computing device 104 instead of falling back to use of AVP.

To perform the probe, in various examples, the first computing device 102 can send a message 112 to the second computing device 104 that requires a response. For example, the first computing device 102 can send a Temporary Maximum Media Stream Bit Rate (TMMBR) message. The TMMBR message 112 can be used by the first computing device 102 to request the second computing device 104 to limit the maximum bit rate of a media stream to be at or below the suggested bit rate. TMMBR is one of the feedback mechanisms included in AVPF. The TMMBR message requires that the second computing device 104 send a response message 114 with a Temporary Maximum Media Stream Bit Rate Notification (TMMBN), which can indicate the second computing device's current view of the most limiting TMMBR-defined limits the second computing device 104 has received. The TMMBN message 114 can inform the first computing device 102 of the second computing device's bit rate limits, so that the first computing device 102 does not send additional TMMBR messages that have no effect on the second computing device 104.

When the first computing device 102 receives a TMMBN message 114 from the second computing device 104 in response to a TMMBR message 112, the first computing device 102 can determine that the second computing device 104 at least supports the TMMBR/TMMBN feedback mechanism, and can configure the session accordingly. When the first computing device 102 does not receive a TMMBN within a specified time limit, it may be that the second computing device 104 does not support TMMBR/TMMBN, or that the second computing device's response was dropped somewhere in the network 150. Because of the possibility of drops, the first computing device 102 may retry the TMMBR a few times before determining that the second computing device 104 does not support TMMBR/TMMBN.

When probing, by the first computing device 102, for feedback types of the second computing device 104 results in the first computing device 102 being unable to identify a feedback message type, the first computing device 102 still need not resort to a non-feedback-message mechanism. Instead, the first computing device 102 can check the periodic RTCP report messages from the second computing device 104 in case the second computing device 104 includes, in a report, an indication of other feedback message types that the second computing device 104 supports. For example, the second computing device 104 may indicate in an RTCP report that the second computing device 104 supports Generic Not-Acknowledged (NACK), Picture Loss Indication (PLI), Slice Loss Indication (SLI), Reference Picture Selection Indication (RPSI), or other feedback message types. When the first computing device 102 identifies one of these feedback message types in an RTCP report, the first computing device 102 can reconfigure the session to use this feedback message type. Reconfiguring an ongoing streaming session can include, for example, generating a new session description and announcing the new session description to the devices in the session. The new session description can indicate that AVPF is available, and can include as an attribute the particular feedback message type supported by the second computing device 104.

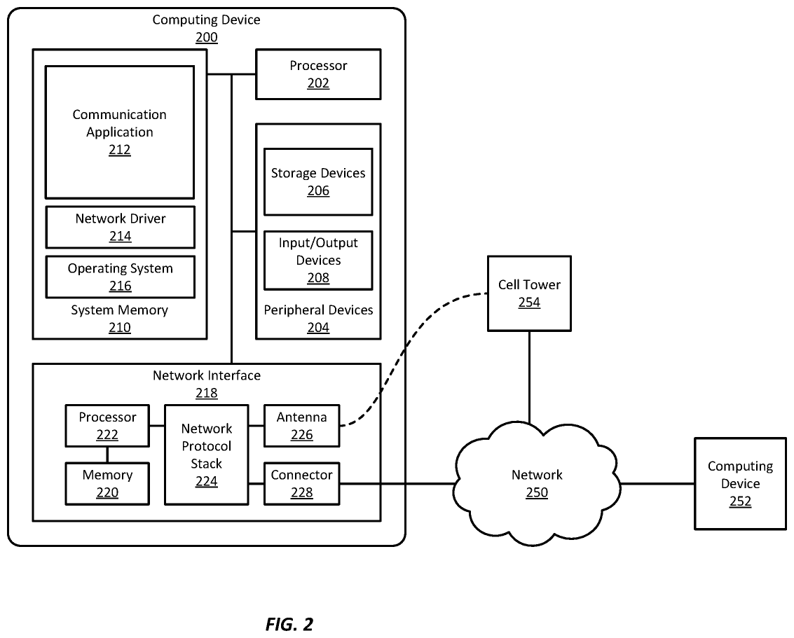

FIG. 2 includes a block diagram of a computing device 200 that can be used to participate in a communication session. The computing device 200 can, for example, initiate a session with another computing device, be the target of a session, and/or join an existing session. The computing device 200 can be, for example, a desktop computer, a laptop computer, a tablet computer, or a smartphone, among other examples. The example computing device 200 can include various hardware components, including a processor 202, a system memory 210 (which can also be referred to as processor memory or main memory), peripheral devices 204, and one or more network interfaces 218, among other examples. When in operation, the computing device 200 can also include software components, such as an operating system 216 and a communication application 212. The computing device 200 can also include software components when not in operation, such as software stored as firmware on other memory devices in the computing device 200, and/or software stored on storage devices 206, among other examples.

The processor 202 is an integrated circuit device that can execute program instructions. The program instructions can be for executing an operating system 216, a communication application 212, and/or a network driver 214, among other examples. When executed by the processor 202, the instructions cause the processor 202 to perform the operations of the program. When being executed by the processor 202, the instructions are stored in the system memory 210, possibly along with data being operated on by the instructions. The system memory 210 can be a volatile memory storage type, such as a Random Access Memory (RAM) type. The system memory 210 is sometimes referred to as Dynamic RAM (DRAM) though it need not be implemented using a DRAM-based technology. Additionally, the system memory 210 can be implemented using non-volatile memory types, such as flash memory.

The operations of the computing device 200 can be coordinated and controlled by the operating system 216. The operating system 216 can, for example, cause the processor 202 to load and execute applications activated by a user, such as the communication application 212 and/or the network driver 214 illustrated in FIG. 2. As a further example, the operating system 216 can control access to and use of the hardware of the computing device 200 by applications executing on the computing device 200.

The communication application 212 of this example is a program that can enable a user of the computing device 200 to initiate and/or receive communication sessions with another computing device 252 located on a network 250. The communication application 212 can be, for example, a telephone dialing application, a voice-over-IP (VOIP) application, a teleconferencing or videoconferencing application, or another type of application that enables voice and/or video communications with the other computing device 252.

In various examples, the communication application 212 may access the network 250 by way of the computing device's network interface 218 and network driver 214. The network driver 214 of this example is a program that can control and provide access to the network interface 218. The network driver 214, for example, can provide an Application Programming Interface (API) that the communication application 212 can use to send data to the network interface 218 for transmission to the network 250. The network driver 214 can also perform operations such as configuring the network interface 218. In various examples, the network driver 214 can access the network interface 218 through interfaces provided by the operating system 216, which may perform operations such as resource sharing, and may provide some system security functions.

The peripheral devices 204 can include various hardware components that can add functionality to the computing device 200. In the example of FIG. 2, the peripheral devices 204 include storage devices 206 and input/output devices 208. The storage devices 206 can include non-volatile storage devices, such as optical or magnetic disks, or solid state drives, among other examples. The storage devices 206 can be internal (e.g., mounted within the same chassis as the other illustrated components) or external (e.g., in a separate enclosure and connected to the computing device 200 using a cable. In some examples, the storage devices 206 can be located on the network 250. The input/output devices 208 can include various devices and/or connectors for devices that enable information to be displayed to a user, and for the user to input data into the computing device 200. For example, the input/output devices 208 can include display devices (e.g., screens or monitors), microphones, speakers, headphones, still and/or video cameras, and/or printers, among other examples. The input/output devices 208 can further include keyboards, mice, touchscreens, digitizing tablets, microphones, motion sensors, and scanners, among other examples. The peripheral devices 204 can include other devices not illustrated here, such as a graphics accelerator.

The network interface 218, which is also a type of peripheral device, enables the computing device 200 to communicate with a network 250. In some examples, the network interface 218 can also include a processor 222, which may be smaller and more simple (and, hence, include less flexibility or fewer capabilities) than the main processor 202 of the computing device 200. The network interface 218 can also include a memory 220 on which firmware to be executed by the processor 222 of the network interface 218 can be stored, as well as other data, such as configuration data for the network interface 218 and/or network configuration data, among other examples. The network interface 218 can also include a network protocol stack 224, implemented in hardware and/or software. The network protocol stack 224 can implement, for example, the Open Systems Interconnection (OSI) reference model. In various examples, network interface 218 can include an antenna 226 capable of connecting the computing device 200 to a cell tower 254 of a cellular network. The cell tower 254 can, at the back-end, connect to the network 250. Alternatively or additionally, the network interface 218 can include a connector 228 that can connect the computing device 200 to the network 250. The connector 228 can be one that accepts a physical cable. Alternatively or additionally, the connector 228 can be an antenna for connecting to shorter-range wireless networks, such as a WiFi network.

As noted above, the communication application 212 can be an application through which a user can have a real-time voice and/or video call with another user on another computing device 252. For example, the user can specify a phone number, an email address, a user identifier, or another identifier that can be associated with a user. In this example, the communication application 212 can communicate through the network driver 214 to the network interface 218, to initiate the call. In initiating the call, the network driver 214 and/or the network interface 218 can generate the SDP packets for initiating and announcing the session, and the network interface 218 can manage the sending of the packets onto the network 250. Alternatively, the network interface 218 can generate the SDP packets, for example using program code executed by the processor 222 and/or through the operations of the network protocol stack 224.

Continuing with the prior example, once the other computing device 252 has joined the session (e.g., the user of the computing device 252 has picked up or otherwise accepted the call), the network driver 214 and/or the network interface 218 can perform session negotiation operations. For example, the network driver 214 and/or the network interface 218 can generate the SDP packets that announce the session configuration and optional session descriptions. Alternatively, the network interface 218 can generate the SDP packets, for example using program code executed by the processor 222 and/or through operations of the network protocol stack 224. In various examples, the network protocol stack 224 and/or the processor 222 of the network interface 218 can receive a response from the computing device 252, and can configure the session accordingly.

In various examples, the network driver 214 and/or the network interface 218 can also perform probing operations to identify types of feedback mechanisms supported by the computing device 252. For example, the network driver 214 can determine from an answer received during session negotiation that the computing device 252 has not provided the feedback types that the computing device 252 supports. The network driver 214 can then generate a packet that requires a reply from the computing device 252, and can use the reply (or lack of a reply) to configure the session. Alternatively, the processor 222 of the network interface 218, through program code executed by the processor 222, can read the answer from the computing device 252, and can generate the packet for probing the computing device 252.

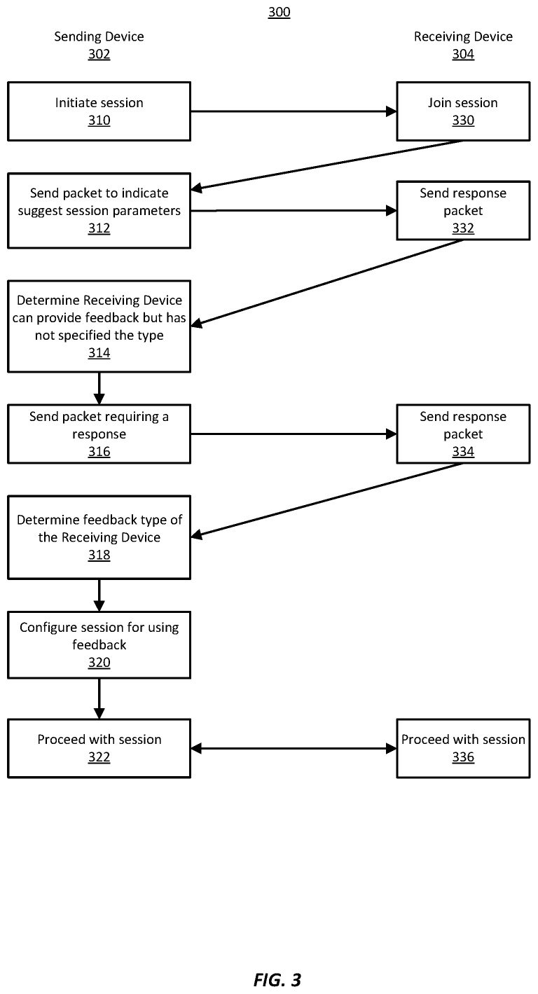

FIG. 3 includes a flow diagram illustrating an example of an exchange of messages 300 between a sending device 302 and receiving device 304 in initiating a session and establishing the session parameters. In this example, the sending device 302 and the receiving device 304 can each be computing devices similar to the computing device described in FIG. 2. The exchange of messages 300 illustrated in FIG. 3 can be exchanged over a variety of different types of networks, as is illustrated in FIG. 1.

In the example of FIG. 3, the sending device 302 initiates a session at step 310. Initiating the session can include, for example, generating and sending a SDP message that announces the session and the session parameters. The SDP message can be sent in a network packet, such as a UDP packet or an IP packet.

At step 330, the receiving device 304 joins the session. In some examples, the receiving device 304 can be the target for the session. In some examples, the receiving device 304 can join the session after the session has been started. In some examples, the receiving device 304 can join the session by obtaining the session parameters from the session announcement and configuring the hardware and/or software of the receiving device 304 to receive the media of the session. In some examples, the receiving device 304 may be required to announce that the receiving device 304 has joined the session.

At step 312, the sending device 302 generates and sends a packet that includes suggested session parameters. The packet can include, for example, session parameters that the sending device 302 intends to use, as well as alternative session descriptions that the sending device 302 would be able to use. In some examples, the sending device 302 generates multiple packets to send the session descriptions. In some examples, the sending device 302 sends the intended and alternative session descriptions in response to an indication that the receiving device 304 has joined the session. In some examples, the sending device 302 sends the session descriptions upon initiating the session.

At step 332, the receiving device 304 receives the packet or packets that include the intended and alternative session descriptions. The receiving device 304 can select from among the intended and alternative session descriptions and can send a response packet, with the selected session description, back to the sending device 302.

At step 314, the sending device 302 receives the response packet from the receiving device 304 and determines from the response packet that the receiving device 304 is capable of using AVPF feedback mechanisms to adjust the parameters of a media stream, and that the receiving device 304 has not specified which feedback message types the receiving device 304 supports.

At step 316, the sending device 302 generates and sends a packet that requires a response from the receiving device 304. The request in the packet can be one of the feedback mechanisms provided by AVPF. For example, the sending device 302 can generate an SDP packet that includes a TMMBR, which suggests a bit rate for the receiving device 304 to use in sending media streams. In other examples, other packet types can be used.

At step 334, the receiving device 304 receives the packet from the sending device 302. In this example, the receiving device 304 supports the particular feedback mechanism used in the packet. The receiving device 304 thus generates and sends a response. In other examples, the receiving device 304 may not support the feedback mechanism used in the packet. In these examples, the receiving device 304 may not be required to reply, and may ignore the packet from the sending device 302.

At step 318, the sending device 302 receives the response from the receiving device 304, and determines that the receiving device 304 at least supports the feedback message type used in the packet generated at step 316. The sending device 302 thus proceeds to step 320, and configures the session for using at least this one feedback message type. At step 322, the sending device 302 then proceeds with the session. Once the session parameters are established by the sending device 302, the receiving device 304 can also, at step 336, proceed with the session.

In other examples, when the receiving device 304 does not support the feedback mechanism used in the packet generated at step 316, the sending device 302 may retry the packet after an interval, on the assumption that the response from the receiving device 304 may have gotten dropped. Once the sending device 302 has retried the packet a certain number of times, the sending device 302 may determine that the receiving device 304 does not support the feedback mechanism used in the packet, and thus may need to configure the session to not use feedback messages. In this situation, however, the sending device 302 can monitor the RTCP reports from the receiving device 304, which may indicate other feedback message types that the receiving device 304 supports.

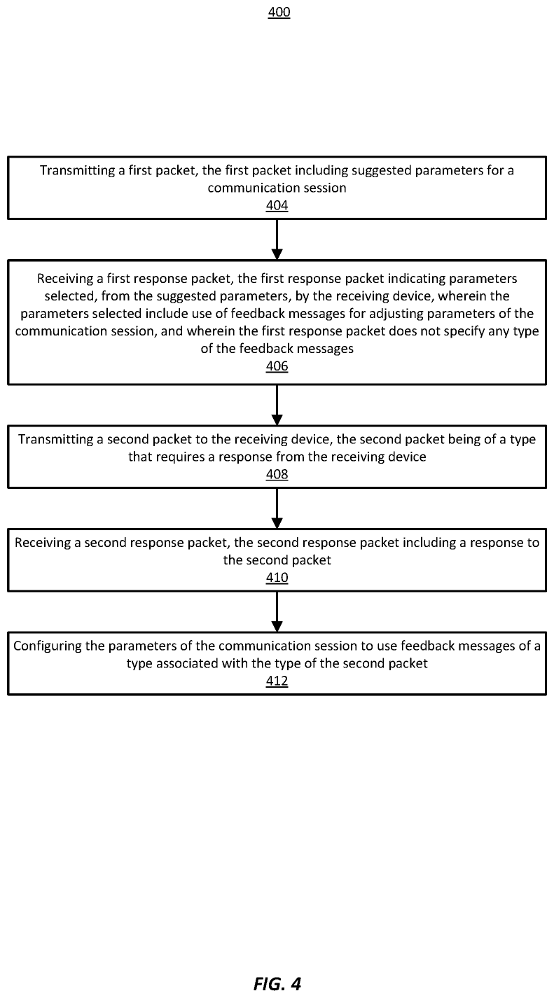

FIG. 4 includes a flowchart illustrating an example of a process 400 for multimedia communications. The example process 400 can be implemented by, for example, a computing device, such as is illustrated in FIG. 2. The computing device can be a sending device in the process 400 of FIG. 4. The computing device can include a processor and a non-transitory computer readable medium having stored thereon instructions that, when executed by the processor, cause the processor to perform the operations of the illustrated process 400. Alternatively or additionally, a non-transitory computer-readable medium can comprise instructions that, when executed by one or more processors of a computing device, can cause the one or more processors to perform the operations of the process 400.

Process 400 may be performed during a communication session with a receiving device, wherein the communication session is established over a network that includes session-based services for data exchanges. The session-based services can use a signaling protocol for real-time communication sessions, wherein the signaling protocol operates on top of a networking protocol. Establishing the communication session can include, for example, sending one or more packets over a network, wherein the one or more packets identify the receiving device or a user associated with the receiving device. Establishing the communication session can further include sending one or more packets that announce the communication session. The packets for establishing the communication session can be, for example, SDP packets. In various examples, the receiving device is also a computing device, such as is illustrated in FIG. 2. In some examples, the communication session includes a video call.

At step 404 of FIG. 4, the process 400 includes transmitting a first packet, the first packet including suggested parameters for the communication session. The suggested parameters can include, for example, a set of parameters the sending device intends to use for the communication session, and/or one or more alternative session descriptions that the sending device can use. In various examples, the suggested parameters include a profile for adjusting the parameters of the communication session. The first packet can be, for example, an SDP packet, such as an SDP Compatibility Negotiation packet.

At step 406, the process 400 includes receiving a first response packet, the first response packet indicating parameters selected, from the suggested parameters, by the receiving device, wherein the parameters selected include use of feedback messages for adjusting parameters of the communication session, and wherein the first response packet does not specify types of the feedback messages. In various examples, the first response packet includes one of the parameters the sending device intends to use or one of the alternative session descriptions sent by the sending device. In various examples, the first response packet can be an SDP packet, such as an SDP Compatibility Negotiation packet.

At step 408, the process 400 includes transmitting a second packet to the receiving device, the second packet being of a type that requires a response from the receiving device. The second packet can be, for example, a TMMBR packet, which suggests a bit rate for the receiving device to use when sending media content.

At step 410, the process 400 includes receiving a second response packet in response to the second packet. The second response packet can be a feedback message of a type that is associated with the type of the second packet. For example, the second response packet can be a TMMBN packet sent in response to a TMMBR packet, where the TMMBN indicates the bit rate that the receiving device will use. Receipt of the second response packet can indicate that the receiving device supports feedback messages of a type associated with the type of the second packet.

At step 412, the process 400 includes configuring the parameters of the communication session to use feedback messages of a type associated with the type of the second packet. Configuring of the parameters can further include using the parameters selected by the receiving device.

In some examples, the process 400 may further include exchanging data between the sending device and the receiving device according to the parameters of the communication session.

In various examples, the process 400 can further include determining, by the sending device, that a second receiving device has joined the communication session. For example, the sending device 302 can receive an announcement message from the second receiving device, or a report message. In these examples, the process 400 can further include transmitting, by the sending device, a third packet to the second receiving device, the third packet being of a same type as the second packet. The third packet can thus require a response from the second receiving device. The process 400 can further include determining, by the sending device, that no response to the third packet was received. The sending device may make this determination after an interval of time has passed and no response was received, and/or after resending the third packet one, two, or another number of times. The process 400 can further include configuring, by the sending device, the parameters of the communication session to not use feedback messages. In some examples, this configuring of parameters of the communication session can affect only the second receiving device. In some examples, this configuring can affect all receiving devices on the session.

In some examples, the process 400 can further include receiving, at the sending device, a periodic report message from the receiving device, the periodic report message including information about the communication session. In various examples, the computing devices in the session can each send report messages. In these and other examples, the process 400 can further include determining, from the periodic report message, a particular type of feedback message supported by the receiving device. The process 400 can further include configuring the parameters of the communication session to use the particular type of feedback message.

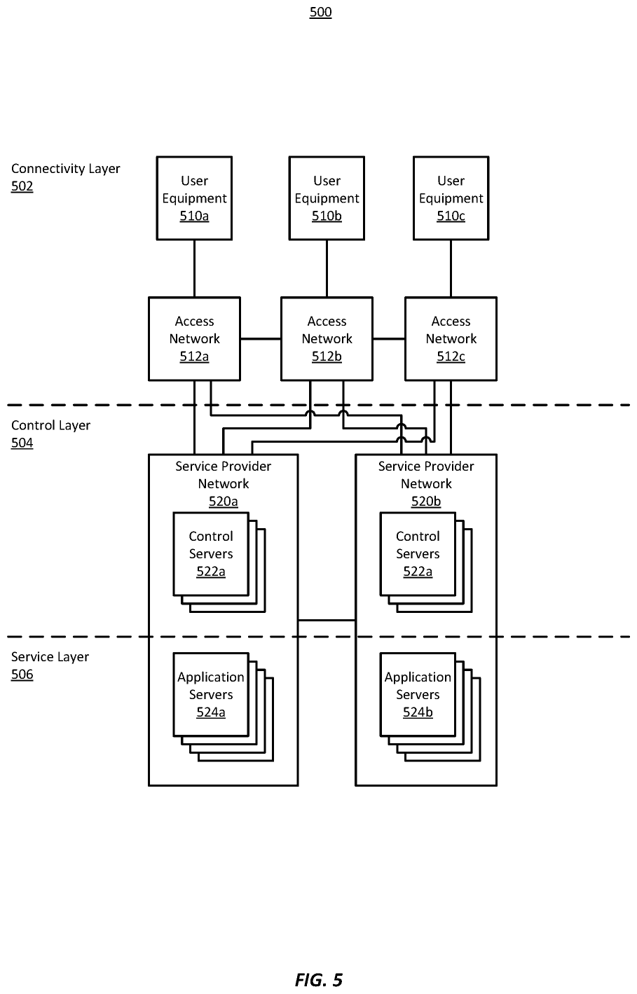

FIG. 5 includes a block diagram illustrating a system 500 according to the IP Multimedia Subsystem (IMS) architectural framework. IMS includes a body of communication protocols and standards that enable computing devices, while connected to disparate types of networks, to gain access to multimedia content and to intercommunicate using voice and/or video. IMS, for example, provides for intercommunication between GSM, WCDMA, CDMA2000, WLAN, WiMAX, LTE, 3G, 4G, 5G, and wired broadband networks, other types of networks, and also future network types.

In various examples, IMS describes the system 500 as having three layers: a connectivity layer 502, a control layer 504, and a service layer 506. Parts of the control layer 504 and/or the service layer 506 may be included in service provider networks 520a-520b, such as a telecommunications service provider or an Internet Service Provider (ISP).

The connectivity layer 502 is the layer at which individual users can connect to the system 500 using computing devices such as laptops and smart phones. The connectivity layer 502 includes access networks 512a-512c and user equipment 510a-510c. The access network 512a-512c include network infrastructure such as routers, switches, and other network elements that can be found at the edge of a provider's network. The user equipment 510a-510c (often abbreviated UE) are endpoint devices in the hands of human operators, and through which the operators can connect to the system 500.

The control layer 504 includes servers that manage operations such as call or data session set-up, as well as modification of sessions and disconnecting and releasing sessions. The core functionality of the system 500 may be found in the control layer 504. The control layer 504 can include different types of control servers 522a-522b for providing this functionality. The control servers 522a-522b can include, for example, a call session control server (CSCF), a home subscriber server (HSS), a server implementing a breakout gateway control function (BGCF), a server implementing a media gateway control function (MGCF), a server implementing a media server control function (MGCF), other servers, and/or multiples of any one of these servers. The CSCF can provide registration of the user equipment 510a-510c, as well as routing for SIP signaling messages. The CSCF can also link to the transport layer to provide Quality of Service (QoS). The HSS can provide a subscriber database for a service provider. The BGCF can select the network in which a PSTN breakout is to occur. When this occurs in the same network as the BGCF, then the BGCF selects the MGCF. The MGCF manages the distribution of sessions across multiple media gateways. The MSCF manages the use of resources on media servers. The control servers 522a-522b may be located in service provider networks 520a-520b.

The service layer 506, which may also be called the application layer, can include content or application servers providing enhanced service features for IMS-enabled networks. The service layer 506 can include, for example, telephony application servers, IP multimedia servers, non-telephony application servers, and various other servers providing other services.

In various examples, the control servers 522a-522b and the application servers 524a-524b can be the networks of one or more service providers. While groups of control servers 522a-522b and application servers 524a-524b are shown here as being in the same service provider networks 520a-520b, in other examples, the control servers 522a-522b and the application servers 524a-524b can be in the networks of different service providers.

Specific details were given in the preceding description to provide a thorough understanding of various implementations of systems and components for establishing parameters for a real-time communication session. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

It is also noted that individual implementations may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

The various examples discussed above may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments). A processor(s), implemented in an integrated circuit, may perform the necessary tasks.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The techniques described herein may also be implemented in electronic hardware, computer software, firmware, or any combination thereof. Such techniques may be implemented in any of a variety of devices such as general-purpose computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, application-specific integrated circuits (ASICs), field-programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor or other means for processing may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for performing the operations of the examples described herein.

What is claimed is:

1. A method for multimedia communications, comprising:
transmitting, by a sending device, a first packet, the first packet including suggested parameters for a communication session with a receiving device;
receiving, at the sending device, a first response packet, the first response packet indicating parameters selected, from the suggested parameters, by the receiving device, wherein the parameters selected include an indication of utilization of feedback messages for adjusting parameters of the communication session, and wherein the first response packet does not specify any type of the feedback messages;
transmitting, by the sending device, a second packet to the receiving device, the second packet being of a type that requires a response from the receiving device;
receiving, at the sending device, a second response packet in response to the second packet; and
configuring, by the sending device, the parameters of the communication session to use feedback messages of a type associated with the type of the second packet.

2. The method of claim 1, wherein the suggested session parameters include a profile for adjusting the parameters of the communication session.

3. The method of claim 1, wherein the second packet includes a suggested bit rate.

4. The method of claim 1, wherein the second response packet indicates that the receiving device supports feedback messages of the type associated with the type of the second packet.

5. The method of claim 1, further comprising:
determining, by the sending device, that a second receiving device has joined the communication session;
transmitting, by the sending device, a third packet to the second receiving device, the third packet being of a same type as the second packet;
determining, by the sending device, that no response to the third packet was received; and
configuring, by the sending device, the parameters of the communication session to not use feedback messages.

6. The method of claim 1, wherein the communication session is established over a network that includes session-based services for data exchanges.

7. The method of claim 6, wherein the session-based services use a signaling protocol for real-time communication sessions, wherein the signaling protocol operates on top of a networking protocol.

8. The method of claim 1, wherein the communication session includes a video call.

9. A computing device, comprising:
a memory configured to store suggested parameters for a communication session with a receiving device; and
a processor comprising an integrated circuit configured to:
transmit a first packet, the first packet including the suggested parameters;
receive a first response packet, the first response packet indicating parameters selected, from the suggested parameters, by the receiving device, wherein the parameters selected include use of feedback messages for adjusting parameters of the communication session, and wherein the first response packet does not specify any type of the feedback messages;
transmit a second packet to the receiving device, the second packet being of a type that requires a response from the receiving device;
receive a second response packet in response to the second packet; and
configure the parameters of the communication session to use feedback messages of a type associated with the type of the second packet.

10. The computing device of claim 9, wherein the suggested session parameters include a profile for adjusting the parameters of the communication session.

11. The computing device of claim 9, wherein the second packet includes a suggested bit rate.

12. The computing device of claim 9, wherein the second response packet indicates that the receiving device supports feedback messages of the type associated with the type of the second packet.

13. The computing device of claim 9, wherein the processor comprising the integrated circuit is further configured to:
determine that a second receiving device has joined the communication session;
transmit a third packet to the second receiving device, the third packet being of a same type as the second packet;
determine that no response to the third packet was received; and
configure the parameters of the communication session to not use feedback messages.

14. The computing device of claim 9, wherein the processor comprising the integrated circuit is further configured to:
receive a periodic report message from the receiving device, the periodic report message including information about the communication session; and
determine, from the periodic report message, a particular type of feedback message supported by the receiving device.

15. The computing device of claim 9, wherein the communication session is established over a network that includes session-based services for data exchanges, and
wherein the session-based services use a signaling protocol for real-time communication sessions, wherein the signaling protocol operates on top of a networking protocol.

16. The computing device of claim 9, wherein the communication session includes a video call.

17. The computing device of claim 9, further comprising a camera and a microphone.

18. The computing device of claim 9, wherein the computing device comprises a mobile device.

19. A non-transitory computer-readable medium comprising instructions that, when executed by one or more processors of a computing device, cause the one or more processors to perform operations including:
transmitting a first packet, the first packet including suggested parameters for a communication session with a receiving device;
receiving a first response packet, the first response packet indicating parameters selected, from the suggested parameters, by the receiving device, wherein the parameters selected include use of feedback messages for adjusting parameters of the communication session, and wherein the first response packet does not specify any type of the feedback messages;
transmitting a second packet to the receiving device, the second packet being of a type that requires a response from the receiving device;
receiving a second response packet in response to the second packet; and
configuring the parameters of the communication session to use feedback messages of a type associated with the type of the second packet.

20. The non-transitory computer-readable medium of claim 19, wherein the suggested session parameters include a profile for adjusting the parameters of the communication session.

21. The non-transitory computer-readable medium of claim 19, wherein the second packet includes a suggested bit rate.

22. The non-transitory computer-readable medium of claim 19, wherein the second response packet indicates that the receiving device supports feedback messages of the type associated with the type of the second packet.

23. The non-transitory computer-readable medium of claim 19, further including instructions that, when executed by the one or more processors, cause the one or more processors to perform operations including:
determining that a second receiving device has joined the communication session;
transmitting a third packet to the second receiving device, the third packet being of a same type as the second packet;
determining that no response to the third packet was received; and
configuring the parameters of the communication session to not use feedback messages.

24. The non-transitory computer-readable medium of claim 19, further including instructions that, when executed by the one or more processors, cause the one or more processors to perform operations including:
receiving a periodic report message from the receiving device, the periodic report message including information about the communication session; and
determining, from the periodic report message, a particular type of feedback message supported by the receiving device.

25. The non-transitory computer-readable medium of claim 19, wherein the communication session is established over a network that includes session-based services for data exchanges, and
wherein the session-based services use a signaling protocol for real-time communication sessions, wherein the signaling protocol operates on top of a networking protocol.

26. The non-transitory computer-readable medium of claim 19, wherein the communication session includes a video call.

27. An apparatus, comprising:
means for transmitting a first packet, the first packet including suggested parameters for a communication session with a receiving device;
means for receiving a first response packet, the first response packet indicating parameters selected, from the suggested parameters, by the receiving device, wherein the parameters selected include use of feedback messages for adjusting parameters of the communication session, and wherein the first response packet does not specify any type of the feedback messages;
means for transmitting a second packet to the receiving device, the second packet being of a type that requires a response from the receiving device;
means for receiving a second response packet in response to the second packet; and
means for configuring the parameters of the communication session to use feedback messages of a type associated with the type of the second packet.

28. The apparatus of claim 27, wherein the suggested session parameters include a profile for adjusting the parameters of the communication session.

29. The apparatus of claim 27, wherein the second packet includes a suggested bit rate.

30. The apparatus of claim 27, wherein the second response packet indicates that the receiving device supports feedback messages of the type associated with the type of the second packet.
